(19) United States
(12) Patent Application Publication
(10) Pub. No.: US 2021/0064235 A1
(43) Pub. Date: Mar. 4, 2021

(54) MEMORY CONTROLLER, FLASH MEMORY SYSTEM HAVING THE SAME, AND FLASH MEMORY CONTROL METHOD

(71) Applicant: TDK Corporation, Tokyo (JP)

(72) Inventor: Kenichi TAKUBO, Tokyo (JP)

(21) Appl. No.: 17/002,453

(22) Filed: Aug. 25, 2020

(30) Foreign Application Priority Data
Sep. 4, 2019 (JP) 2019-161052

(51) Int. Cl. G06F 3/06; G06F 11/10

(52) U.S. Cl. CPC G06F 3/061; G06F 11/1068; G06F 3/0679; G06F 3/0659

(57) ABSTRACT

Disclosed herein a memory controller that controls data transfer between a host system and a flash memory. The memory controller is configured to execute background processing with a reduced throughput during a period during which processing corresponding to a command issued from the host system is not performed.

### BACKGROUND OF THE INVENTION

### Field of the Invention

The present invention relates to a memory controller, a flash memory system having the same, and a flash memory control method and, more particularly to, a memory controller capable of reducing heat generation during operation of a flash memory system, a flash memory system having the same, and a flash memory control method.

### Description of Related Art

A flash memory system has a memory controller provided between a host system and a flash memory. The memory controller controls the operation of the entire flash memory system and data transfer between the host system and flash memory.

The memory controller executes background processing such as garbage collection or bit error correction when processing based on a command issued from the host system is not performed (see JP 2019-106197A). Further, in the flash memory system using a flash memory, data transfer processing between physical blocks in the flash memory may be performed frequently. This data transfer is performed, e.g., for wear leveling (wear leveling between physical blocks) or for saving data that is written in a physical block in which a data error has occurred in another block. In this data transfer, data that is written in the flash memory is read out into a buffer memory once and is then written into the flash memory again. Thus, in the data transfer between physical blocks, data is transferred between the memory controller and flash memory.

In general, heat generation during operation of the flash memory system significantly depends on the data transfer between the memory controller and flash memory. Thus, even in a period during which processing based on a command from the host system is not performed, heat generation can occur when data transfer between the memory controller and flash memory is performed in the background processing, and a thermal runaway occurs, in some cases.

### SUMMARY

It is therefore an object of the present invention to provide a memory controller capable of reducing heat generation during operation of a flash memory without involving a decrease in access speed from a host system, a flash memory system having the same, and a flash memory control method.

A memory controller according to the present invention is a memory controller that controls data transfer between a host system and a flash memory and is featured in that it executes background processing with a reduced throughput during a period during which processing corresponding to a command issued from the host system is not performed. Further, a flash memory system according to the present invention has the above memory controller and flash memory. Furthermore, a flash memory control method according to the present invention is a method of controlling the flash memory based on a command issued from a host system and is featured in that background processing is performed with a reduced throughput during a period during which processing corresponding to a command issued from the host system is not performed.

According to the present invention, the background processing is executed with a reduced throughput, thereby making it possible to reduce a heat generation amount during operation of the flash memory system.

In the present invention, the throughput during the background processing may be reduced by setting an interval period during which the flash memory is not accessed during the background processing. Alternatively, the throughput during the background processing may be reduced by reducing the frequency of an operation clock during the background processing. Further alternatively, the throughput during the background processing may be reduced by restricting the number of parallel accesses to a plurality of flash memories. In any of the above methods, a data transfer rate between the memory controller and flash memory is made lower than a maximum data transfer rate, thereby reducing a heat generation amount during the background processing.

As described above, according to the present invention, it is possible to reduce heat generation during operation of the flash memory system.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram for explaining a flash memory system 2 according to a preferred embodiment of the present invention;

FIG. 2 is a flowchart for explaining the operation of the flash memory system 2;

FIG. 3 is a schematic graph illustrating a change in power consumption; and

FIG. 4 is a schematic graph illustrating an average power consumption.

### DETAILED DESCRIPTION OF THE EMBODIMENTS

Hereinafter, a preferred embodiment of the present invention will be described in detail with reference to the accompanying drawings.

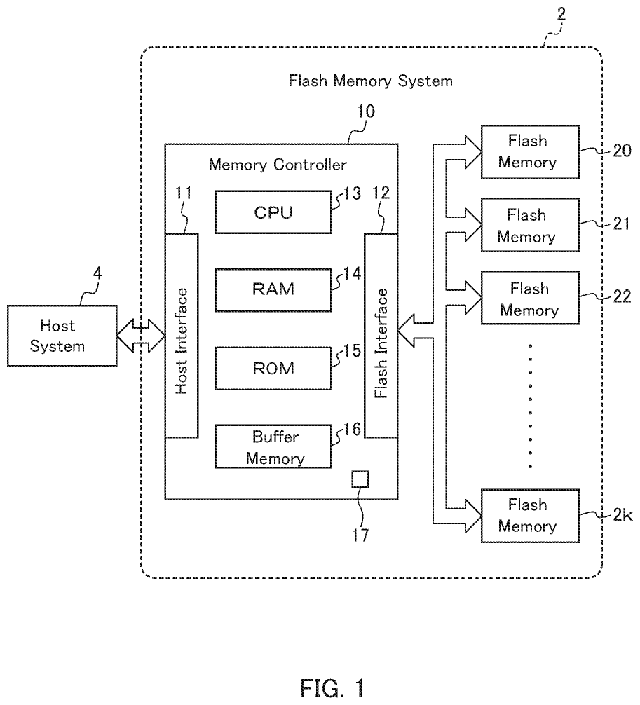

FIG. 1 is a block diagram for explaining the configuration of a flash memory system 2 according to a preferred embodiment of the present invention.

The flash memory system 2 according to the present embodiment includes a memory controller 10 and a plurality of flash memories 20 to 2k. Although not particularly limited, the flash memories 20 to 2k are each a NAND-type flash memory. Although (k+1) flash memories 20 to 2k are mounted in the example of FIG. 1, the number of the flash memories is not particularly limited.

The memory controller 10 is provided between an external host system 4 and the flash memories 20 to 2k and controls data transfer therebetween. The host system 4 and memory controller 10 exchange data and commands through a host interface 11, and the flash memories 20 to 2k and memory controller 10 exchange data and commands through a flash interface 12.

The memory controller 10 includes a CPU 13, a RAM 14, a ROM 15, and a buffer memory 16. The CPU 13 controls the operation of the entire memory controller 10 according to programs stored in the ROM 15. The programs stored in the ROM 15 may be expanded in the RAM 14 at power-on time. Alternatively, some programs may be stored in the flash memory and expanded in the RAM 14 from the flash memory at power-on time. The RAM 14 is a work area that temporarily stores data necessary to control the flash memories 20 to 2k and is constituted by, e.g., a plurality of SRAM cells. The buffer memory 16 is a circuit that temporarily stores read data read out from the flash memories 20 to 2k and write data to be written into the flash memories 20 to 2k (a part of the RAM 14 may be used as the buffer memory 16). Thus, the write data supplied from the host system 4 are temporarily stored in the buffer memory 16 and then transferred to the flash memories 20 to 2k through the flash interface 12 after the flash memories 20 to 2k are in a data-writable state. The read data read out from the flash memories 20 to 2k are temporarily stored in the buffer memory 16 and then transferred to the host system 4 through the host interface 11 after the host system 4 is in a data-receivable state.

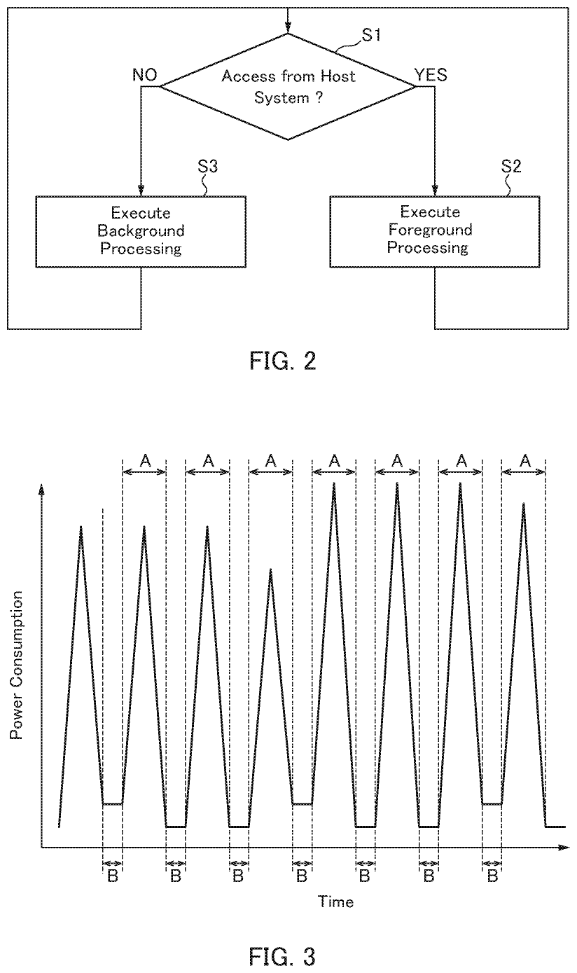

Processing carried out by the memory controller 10 includes foreground processing performed based on a command issued from the host system 4 and background processing performed independently of a command issued from the host system 4. That is, as illustrated in FIG. 2, when a command is issued from the host system 4 (YES in step S1), the memory controller 10 executes the foreground processing based on the issued command (step S2). The content of processing to be actually executed is determined based on the type of a command, and a read operation or a write operation with respect to the flash memories 20 to 2k is performed, for example. When completing the foreground processing based on a command issued from the host system 4 (NO in step S1), the memory controller 10 executes the background processing (step S3). When a new command is issued from the host system 4 during the background processing (YES in step S1), the memory controller 10 interrupts the background processing and executes new foreground processing based on the issued command (step S2).

The background processing includes garbage collection, bit error correction, and the like. The garbage collection is processing of generating a free block by transferring dispersed valid data to other blocks and involves a large amount of data transfer between the memory controller 10 and flash memories 20 to 2k. The bit error correction is processing of correcting bit errors included in data read out from the flash memories 20 to 2k by referring to ECC (Error Correction Code). Processing like the garbage collection, that involves a large amount of data transfer between the memory controller 10 and flash memories 20 to 2k includes a read operation, a write operation, and an erase operation with respect to the flash memories 20 to 2k and thus increases heat generation.

The memory controller 10 according to the present embodiment executes the background processing with a reduced throughput. That is, the memory controller 10 executes the background processing with a predetermined throughput lower than a maximum throughput. Specifically, a data transfer rate per unit time between the memory controller 10 and flash memories 20 to 2k is made lower than a maximum data transfer rate per unit time. This makes it possible to reduce a heat generation amount per unit time as compared to a case where the background processing is executed with a maximum throughput. On the other hand, when processing a command issued from the host system 4, the data transfer rate per unit time between the memory controller 10 and flash memories 20 to 2k is not restricted. Thus, when commands are issued in a concentrated manner, the data transfer rate per unit time between the memory controller 10 and flash memories 20 to 2k sometimes reaches a maximum data transfer rate.

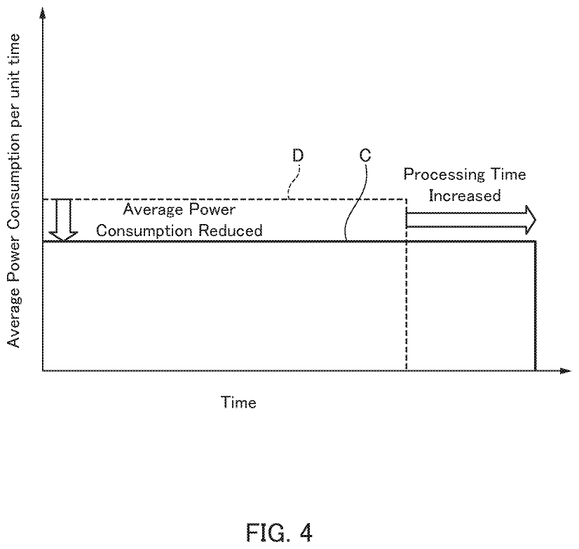

There is no particular restriction on a method of reducing the throughput during execution of the background processing, and the following first to third methods can be employed. The first method is to set an interval period in the background processing, during which the flash memories 20 to 2k are not accessed. That is, the throughput is reduced by inserting an interval period during which no access is made to the flash memories 20 to 2k between when a given access to the flash memories 20 to 2k is completed to when the next access is made to the flash memories 20 to 2k. FIG. 3 is a schematic graph illustrating a change in power consumption when the first method is employed. As illustrated in the graph, the background processing is intermittently executed such that a period A during which the flash memories 20 to 2k are accessed and a period B during which the flash memories 20 to 2k are not accessed alternately appear. In this case, power consumption in the period B corresponding to the above interval period is significantly small, so that the average power consumption is reduced as denoted by the solid line C of FIG. 4 to thereby reduce heat generation. The dashed line D of FIG. 4 denotes the average power consumption when the background processing is executed without reducing the throughput. Thus, it can be seen that the average power consumption denoted by the solid line C is lower than the average power consumption denoted by the dashed line D. However, since the throughput is reduced, a time required to complete a series of background processing increases correspondingly.

The second method is to reduce the frequency of an operation clock during the background processing. That is, the frequency of an operation clock during execution of the background processing is made lower than the frequency of an operation clock during execution of the foreground processing performed based on a command issued from the host system. This makes it possible to reduce the throughput during the background processing without inserting the interval period of the first method.

The third method is to restrict the number of parallel accesses to the flash memories 20 to 2k. That is, parallel accesses can be made to the flash memories 20 to 2k, and the number of parallel accesses thereto is made smaller than the maximum number of parallel accesses. This makes it possible to reduce the throughput during the background processing without inserting the interval period or changing the clock frequency.

The reduction amount of the throughput during the background processing is preferably set to 30% or more of a throughput when it is not restricted. In other words, the data transfer rate per unit time between the memory controller 10 and flash memories 20 to 2k is preferably controlled to 70% or less of a maximum data transfer rate per unit time. This can achieve a significant reduction in heat generation amount.

Further, the background processing may be executed with the throughput reduced always or only when a predetermined condition is satisfied. In the latter case, for example, a temperature sensor 17 may be provided in the memory controller 10, and whether the throughput is reduced or not may be determined based on a temperature measured using the temperature sensor 17. Specifically, when a temperature measured using the temperature sensor 17 is equal to or less a prescribed value, the background processing is executed without reducing the throughput, while when a temperature measured using the temperature sensor 17 exceeds the prescribed value, the background processing is executed with a reduced throughput. Further, the reduction amount of the throughput may be changed according to the temperature measured using the temperature sensor 17. For example, the throughput may be reduced by about 20% when the measured temperature falls within a first temperature range, and the throughput may be reduced by about 40% when the measured temperature falls within a second temperature range.

It is apparent that the present invention is not limited to the above embodiments, but may be modified and changed without departing from the scope and spirit of the invention.

What is claimed is:

1. A memory controller controlling data transfer between a host system and a flash memory,
wherein the memory controller is configured to execute background processing with a reduced throughput during a period during which processing corresponding to a command issued from the host system is not performed.

2. The memory controller as claimed in claim 1, wherein the throughput during the background processing is reduced by setting an interval period during which the flash memory is not accessed during the background processing.

3. The memory controller as claimed in claim 1, wherein the throughput during the background processing is reduced by reducing a frequency of an operation clock during the background processing.

4. The memory controller as claimed in claim 1, wherein the throughput during the background processing is reduced by restricting a number of parallel accesses to a plurality of flash memories.

5. A flash memory system comprising a memory controller and flash memory,
wherein the memory controller controls data transfer between a host system and the flash memory, and
wherein the memory controller is configured to execute background processing with a reduced throughput during a period during which processing corresponding to a command issued from the host system is not performed.

6. A method for controlling a flash memory based on a command issued from a host system, the method comprising performing a background processing with a reduced throughput during a period during which processing corresponding to a command issued from the host system is not performed.
